(19) United States
(12) Patent Application Publication
(10) Pub. No.: US 2007/0195120 A1
(43) Pub. Date: Aug. 23, 2007

(54) METHOD OF CONTROLLING INK EJECTING CHARACTERISTICS OF INKJET HEAD

(76) Inventors: Jong-beom KIM, Yongin-si (KR); Yong-soo Lee, Yongin-si (KR); Jaw-woo Chung, Yongin-si (KR)

Correspondence Address: STANZIONE & KIM, LLP, 919 18TH STREET, N.W., SUITE 440, WASHINGTON, DC, 20006, US

(21) Appl. No.: 11/620,788

(22) Filed: Jan. 8, 2007

(30) Foreign Application Priority Data
Feb. 22, 2006 (KR) 2006-17246

(51) Int. Cl. B41J 29/38; B41J 29/393

(52) U.S. Cl. 347/19; 347/14

(57) ABSTRACT

A method of controlling ink ejecting characteristics of an inkjet head with a plurality of nozzles. The method includes measuring initial ink ejecting characteristics of all the nozzles, comparing the measured values to a preset target point and calculating gradients from the measured values to the target point for all the nozzles, adjusting waveforms of driving pulses of the nozzles based on the calculated gradients; applying the adjusted driving pulses to all the nozzles and measuring ink ejecting characteristics of all the nozzles, and determining whether the measured results for all the nozzles are within a range of the target point, wherein the method is stopped when the measured results of all the nozzles are within the range of the target point, and the method returns to the comparing operation when the measured results of all the nozzles are not within the range of the target point. The controlling method simultaneously adjusts the ink ejecting characteristics of the nozzles, and adjusts both the ejecting speed and volume of ink from each nozzle, to minimize the time required to make the ink ejecting characteristics of all the nozzles uniform.

### CROSS-REFERENCE TO RELATED APPLICATIONS

This application claims the benefit of Korean Patent Application No. 10-2006-0017246, filed on Feb. 22, 2006, in the Korean Intellectual Property Office, the disclosure of which is incorporated herein in its entirety by reference.

### BACKGROUND OF THE INVENTION

1. Field of the Invention

The present general inventive concept relates to a method of controlling the ink ejecting characteristic of an inkjet head, and more particularly, to a method of controlling the ejecting characteristic of ink droplets ejected through a plurality of nozzles of an inkjet head.

2. Description of the Related Art

Inkjet heads are devices that eject minute droplets of printing ink onto a print medium at a desired location to print an image of a predetermined color. Such inkjet heads may employ various ink ejecting mechanisms, for example, the use of piezoelectric actuators that undergo a piezoelectric deformation to eject ink. Such inkjet heads are called piezoelectric inkjet heads.

In a piezoelectric inkjet head, when a driving pulse with a predetermined driving voltage is applied to a piezoelectric actuator, the piezoelectric actuator deforms, which causes a vibration plate to bend, thereby increasing pressure on a pressure chamber so that ink droplets are ejected to the outside through nozzles connected to the pressure chamber.

FIG. 1 is a graph illustrating an example of a driving pulse applied to a piezoelectric actuator of a conventional inkjet head.

Referring to FIG. 1, a conventional driving pulse has a trapezoidal waveform and a predetermined driving voltage Vₚ sustained over a voltage sustaining time T_{D}. The ejecting characteristic (speed and volume) of ink droplets ejected through nozzles of an inkjet head changes according to the waveform of a driving pulse. Generally, the speed at which ink droplets are ejected through the nozzles of an inkjet head is mostly affected by the driving voltage Vₚ, and the ejected volume of the ink droplet is mostly affected by the voltage sustaining time V_{D}. That is, when the driving voltage Vₚ is increased, the speed at which ink droplets are ejected increases, and when the voltage sustaining time V_{D} is lengthened, the ejected volume of the ink droplet increases. However, the speed and volume of the ejected ink droplet are not completely independent of each another.

In the prior art, one of the two variables (for example, the driving voltage Vₚ) is first changed to adjust the ejecting speed of the ink droplet, and then the other variable (the voltage sustaining time V_{D}) is changed to adjust the ejecting volume of the ink droplet. Specifically, in the prior art, after the initial ink ejecting characteristic (speed and volume) at one nozzle is measured at an initial measured point P₀, the first variable (for example, the driving voltage Vₚ) is changed to adjust the ejecting speed of the ink droplet at measured points P₁₁, P₁₂, P₁₃, and P₁₄, as illustrated by the solid lines in FIG. 3. Next, the second variable (for example, the voltage sustaining time T_{D}) is changed to adjust the ejected volume of the ink droplet at a measured point P₁₅, and then the first variable (for example, the driving voltage Vₚ) is changed to adjust the ejecting speed of the ink droplet at a measured point P₁₆. By repeating this process, the ink ejecting characteristic (ejecting speed and volume) can ultimately reach a target point.

However, this type of conventional method of sequentially and repetitively performing ink ejecting adjustments in terms of speed and volume requires a lot of time to attain the target point.

Also, because an inkjet head is provided with a plurality of nozzles (tens to hundreds of nozzles, for instance), the ejecting characteristic (ejecting speed and volume) of the ink droplets must be uniform throughout the plurality of nozzles.

In the prior art, the above-described variables are adjusted for each nozzle to attain a target point of an ink ejecting characteristic. However, in an inkjet head with multiple nozzles, a cross talk phenomenon (wherein ink ejecting characteristics of neighboring nozzles affect one another) occurs. Therefore, even when one nozzle's ink ejecting characteristic is adjusted, when the next nozzle's ink ejecting characteristic is adjusted, cross talk occurs, thereby shifting the adjusted ink ejecting characteristic of the first nozzle out of the target point area. In this case, after the ink ejecting characteristics of all the nozzles have been adjusted, when all the nozzles are operated and their ink ejecting characteristics are measured, some of the nozzles are discovered to have ink ejecting characteristics outside of the target point area. Thus, in the prior art, nozzles whose ink ejecting characteristics have deviated from the target point area are individually re-adjusted. In order to make the ink ejecting characteristics of all the nozzles uniform, the above process is repeated a plurality of times.

As described above, in the prior art, the adjusting of the ink ejecting characteristics for each of a plurality of nozzles and the measuring of the ink ejecting characteristics for all of the nozzles are repeated a number of times in order to make the ink ejecting characteristics for a multi-nozzle inkjet head uniform. However, in this prior art method, the process of adjusting the ink ejecting characteristics of each of a plurality of nozzles must be repeated, which is time consuming and thereby reduces the productivity of the method.

### SUMMARY OF THE INVENTION

The present general inventive concept provides a method of controlling the ink ejecting characteristic of an inkjet head, which minimizes the time needed to adjust the ink ejecting characteristics of a plurality of nozzles through which ink droplets are ejected.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing a method of controlling ink ejecting characteristics of an inkjet head having a plurality of nozzles through which ink droplets are ejected, the method including: measuring initial ink ejecting characteristics of all the nozzles; comparing the measured values to a preset target point, and calculating gradients from the measured values to the target point for all the nozzles; adjusting waveforms of driving pulses of all the nozzles based on the calculated gradients; applying the adjusted driving pulses to all the nozzles, and measuring ink ejecting characteristics of all the nozzles; and determining whether the measured results for all the nozzles are within a range of the target point, wherein the method is stopped when the measured results of all the nozzles are within the range of the target point, and the method returns to the comparing operation when the measured results of all the nozzles are not within the range of the target point.

The measuring of the initial ink ejecting characteristics and the measuring of the ink ejecting characteristics of the nozzles may be performed while simultaneously operating all the nozzles.

The ink ejecting characteristics may include an ink ejecting speed and an ink ejecting volume, and the ink ejecting speed and the ink ejecting volume may be adjusted simultaneously.

The calculating of the gradients may be performed based on the shortest routes between the measured results and the target point for each of the nozzles.

The adjusting of the waveforms may be performed such that a driving voltage (Vp) and a voltage sustaining time (TD) are simultaneously adjusted for each of the nozzles.

The ink ejecting characteristics may include an ink ejecting speed and an ink ejecting volume, and one of the ink ejecting speed and the ink ejecting volume may be adjusted.

The foregoing and/or other aspects and utilities of the present general inventive concept may also be achieved by providing a method of controlling ink ejecting characteristics of an inkjet head in order to simultaneously adjust an ink ejecting speed and an ink ejecting volume for each of a plurality of nozzles provided on the inkjet head, the method including: measuring the ink ejecting speed and the ink ejecting volume of the nozzle; comparing the measured results with a preset target point, and calculating a gradient from the measured results to the target point; simultaneously adjusting a driving voltage (Vp) and a voltage sustaining time (TD) of a driving pulse for the nozzle based on the calculated gradient; applying the adjusted driving pulse to the nozzle, and measuring the ink ejecting speed and the ink ejecting volume of the nozzle; and determining whether the measured results of the nozzle are within a range of the target point, wherein the method is terminated when the measured results of the nozzle are within the range of the target point, and the method returns to the comparing operation when the measure results of the nozzle are not within the range of the target point.

The calculating of the gradient may be performed based on the shortest route between the measured results and the target point.

The foregoing and/or other aspects and utilities of the present general inventive concept may also be achieved by providing a method of controlling ink ejecting characteristics of an inkjet head having a plurality of nozzles through which ink droplets are ejected, the method including measuring a plurality of initial ink ejecting characteristics of all the nozzles, adjusting waveforms of driving pulses of the nozzles based on the measured charateristics, applying the adjusted driving pulses to all the nozzles and obtaining a second measurement of ink ejecting characteristics of all the nozzles, and returning to the adjusting of the waveforms of the driving pulses of the nozzles until the measurement results for all the nozzles are within a range of a target point.

The foregoing and/or other aspects and utilities of the present general inventive concept may also be achieved by providing a method of controlling ink ejecting characteristics of an inkjet head having a plurality of nozzles through which ink droplets are ejected, the method including measuring initial ink ejecting characteristics of all the nozzles simultaneously, comparing the measured values to a preset target point and adjusting waveforms of driving pulses of the nozzles based on the comparison results

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a graph illustrating an example of a driving pulse applied to a piezoelectric actuator of a conventional inkjet head;

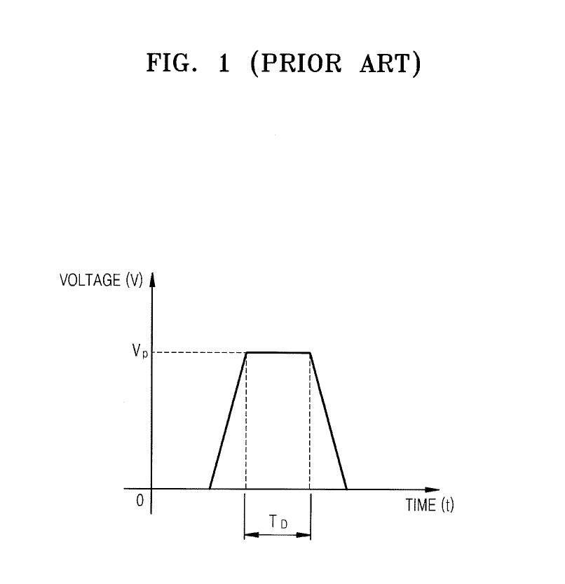

FIG. 2 is a flowchart illustrating a method of controlling an ink ejecting characteristic according to an embodiment of the present general inventive concept; and

FIG. 3 is a graph comparing operations S2 and S3 illustrated in FIG. 2 to a conventional controlling method.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

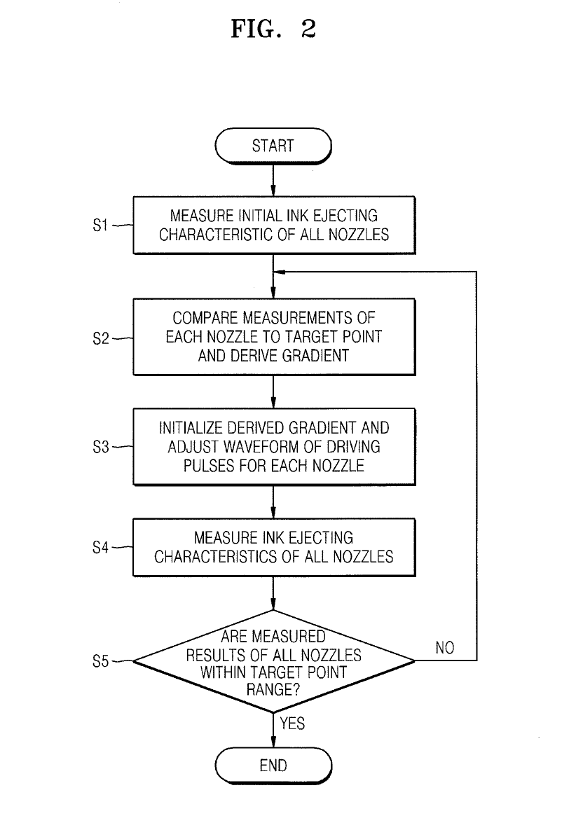

FIG. 2 is a flowchart illustrating a method of controlling an ink ejecting characteristic according to an embodiment of the present general inventive concept.

Referring to FIG. 2, a method of controlling ink ejecting characteristics according to an embodiment of the present general inventive concept is characterized by simultaneous adjusting of ink ejecting characteristics of a plurality of nozzles provided on an inkjet head.

In further detail, all the nozzles of an inkjet head are simultaneously operated, and the initial ink ejecting characteristics (i.e., the ejecting speed and volume) of each of the nozzles are measured in operation S1. Here, a driving pulse with a predetermined driving voltage Vₚ and a voltage sustaining time T_{D}, can be applied to all the nozzles to drive them simultaneously. Accordingly, the ink ejecting characteristics of the nozzles affected by the cross talk phenomenon, in which neighboring nozzles affect one another, can be measured.

Next, the measured results of all the nozzles are compared to a preset target point, and a gradient is determined between the measured result of each nozzle and the target point in operation S2. The gradient can be provided in the form of, for example, a table, slope, etc.

Then, based on the gradients derived in operation S2, a waveform of a driving pulse for each nozzle is adjusted in operation S3.

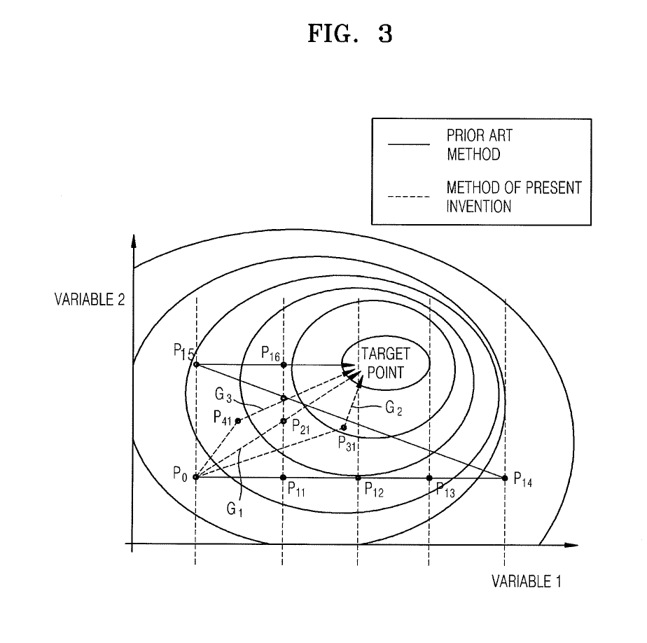

A detailed description of operations S2 and S3 will be given later with reference to FIG. 3.

Thereafter, the driving pulse adjusted in operation S3 is applied to all the nozzles to simultaneously drive all the nozzles, and the ink ejecting characteristics of all the nozzles are measured in operation S4. Here, because all the nozzles are simultaneously driven, the measured results reflecting the cross talk phenomenon between neighboring nozzles can be obtained.

Subsequently, it is determined in operation S5 whether the measured results of all the nozzles are within the range of the target point. If the measured results of all the nozzles are within the range of the target point, the adjusting of the ink ejecting characteristics is ended. If all or a portion of the measured results of the nozzles are outside the range of the target point, operations S2 through S5 are performed again for the nozzles whose results are outside the target point range. When this process is repeated a number of times, the ink ejecting characteristics for all the nozzles can be adjusted to be within the target point range.

As described above, according to the present general inventive concept, in the method of controlling the ink ejecting characteristics, the ink ejecting characteristics of a plurality of nozzles are adjusted simultaneously so that the cross talk phenomenon that occurs between neighboring nozzles during the process is identified. Thus, unlike in the prior art method in which the ink ejecting characteristics for each nozzle are sequentially adjusted and then differences created by the cross talk phenomenon are adjusted, in the present general inventive concept, the ink ejecting characteristics of all the nozzles are made uniform simultaneously, thereby minimizing the execution time of the method.

FIG. 3 is a graph comparing operations S2 and S3 illustrated in FIG. 2 to a conventional controlling method.

Referring to FIG. 3, in operation S2, the respective measured results of all the nozzles are compared to the target point, and a gradient from each measured result to the target point is calculated. Here, the gradient for each nozzle is the shortest route G₁ from the nozzle's measured result to the target point.

In operation S3, the waveforms for the driving pulses of each nozzle are adjusted based on the gradients derived in operation S2. Here, both the driving voltage Vₚ and the voltage sustaining time T_{D} of the driving pulse for each nozzle are adjusted, so that the ink ejecting characteristics (the ejecting speed and volume) are adjusted together.

Through this adjusting, the resulting value measured in operation S4 may lie on a measuring point P₂₁ on the route G₁ (preferable case), or that resulting value may lie on measuring points P₃₁ and P₄₁ outside of the route G₁. In the former case, the driving voltage Vₚ and the voltage sustaining time T_{D} are adjusted together along the same route G₁ by repeating operations S2 and S3. In the latter case, the shortest routes G₂ and G₃ are calculated again from the measured points P₃₁ and P₄₁ to the target point, and the driving voltage Vₚ and the voltage sustaining time T_{D} are adjusted together based on the newly calculated shortest route G₂ and G₃. After the above operations are repeated several times, the ink ejecting characteristic (the ejecting speed and volume) of each nozzle reach the target point.

As described above, the ejecting speed and volume of ink droplets for each nozzle are adjusted at the same time in the present embodiment, obviating the need to separately adjust the speed and volume like in the prior art, so that the target point for ink ejecting characteristics is reached more quickly than in the prior art.

The method of controlling the ink ejecting characteristics of the present general inventive concept may be applied to adjust only one of the ink ejecting speed and volume. In this case, instead of simultaneously adjusting the ejecting speed and volume in operations S2 and S3, only one of the ejecting speed and volume is adjusted.

Also, the described method of simultaneously controlling the ejecting speed and volume in operations S2 and S3 may be applied not only to adjusting the ink ejecting characteristics for all the nozzles simultaneously, but also to adjusting the ink ejecting characteristics for each nozzle in sequence.

As described above, according to the present general inventive concept, in the method of simultaneously controlling the ink ejecting characteristics for a plurality of nozzles, the cross talk between neighboring nozzles can be accounted for. Thus, the time needed to make the ink ejecting characteristics for all the nozzles uniform is minimized.

Additionally, according to the present general inventive concept, the method of simultaneously controlling the ink ejecting characteristics for each nozzle allows the ink ejecting characteristics to reach a target point in a shorter amount of time.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of controlling ink ejecting characteristics of an inkjet head having a plurality of nozzles through which ink droplets are ejected, the method comprising:
measuring initial ink ejecting characteristics of all the nozzles;
comparing the measured values to a preset target point, and calculating gradients from the measured values to the target point for all the nozzles;
adjusting waveforms of driving pulses of the nozzles based on the calculated gradients;
applying the adjusted driving pulses to all the nozzles, and measuring ink ejecting characteristics of all the nozzles; and
determining whether the measured results for all the nozzles are within a range of the target point,
wherein the method is stopped when the measured results of all the nozzles are within the range of the target point, and the method returns to the comparing operation when the measured results of all the nozzles are not within the range of the target point.

2. The method of claim 1, wherein the measuring of the initial ink ejecting characteristics and the measuring of the ink ejecting characteristics are performed while simultaneously operating all the nozzles.

3. The method of claim 1, wherein the ink ejecting characteristics comprises an ink ejecting speed and an ink ejecting volume, and the ink ejecting speed and the ink ejecting volume are adjusted simultaneously.

4. The method of claim 3, wherein the calculating of the gradients is performed based on the shortest routes between the measured results and the target point for each of the nozzles.

5. The method of claim 3, wherein the adjusting of the waveforms is performed such that a driving voltage (Vₚ) and a voltage sustaining time (T_{D}) are simultaneously adjusted for each of the nozzles.

6. The method of claim 1, wherein the ink ejecting characteristics include an ink ejecting speed and an ink ejecting volume, and one of the ink ejecting speed and the ink ejecting volume is adjusted.

7. A method of controlling ink ejecting characteristics of an inkjet head, to simultaneously adjust an ink ejecting speed and an ink ejecting volume for each of a plurality of nozzles provided on the inkjet head, the method comprising:
measuring the ink ejecting speed and the ink ejecting volume of the nozzle;
comparing the measured results with a preset target point, and calculating a gradient from the measured results to the target point;
simultaneously adjusting a driving voltage (Vp) and a voltage sustaining time (TD) of a driving pulse for the nozzle based on the calculated gradient;
applying the adjusted driving pulse to the nozzle and measuring the ink ejecting speed and the ink ejecting volume of the nozzle; and
determining whether the measured results of the nozzle are within a range of the target point,
wherein the method is terminated when the measured results of the nozzle lie within the range of the target point, and the method returns to the comparing operation when the measured results of the nozzle are not within the range of the target point.

8. The method of claim 7, wherein the calculating of the gradient is performed based on the shortest route between the measured results and the target point.

9. A method of controlling ink ejecting characteristics of an inkjet head having a plurality of nozzles through which ink droplets are ejected, the method comprising:
measuring a plurality of initial ink ejecting characteristics of all the nozzles;
adjusting waveforms of driving pulses of the nozzles based on the measured characteristics;
applying the adjusted driving pulses to all the nozzles and obtaining a second measurement of ink ejecting characteristics of all the nozzles; and
returning to the adjusting of the waveforms of the driving pulses of the nozzles until the measurement results for all the nozzles are within a range of a target point.

10. The method of claim 9, wherein the adjusting of the waveforms of the driving pulses comprises:
calculating gradients from the measured values to the target point for all the nozzles; and
adjusting waveforms of driving pulses of the nozzles based on the calculated gradients.

11. The method of claim 9, wherein the measuring of the plurality of initial ink ejecting characteristics of all the nozzles is performed simultaneously.

12. A method of controlling ink ejecting characteristics of an inkjet head having a plurality of nozzles through which ink droplets are ejected, the method comprising:
measuring initial ink ejecting characteristics of all the nozzles simultaneously;
comparing the measured values to a preset target point; and
adjusting waveforms of driving pulses of the nozzles based on the comparison results.

13. The method of claim 12, wherein the measuring, comparing and adjusting operations are performed repeatedly until measured results of the nozzles are within the range of the target point.
